(19) United States
(12) Patent Application Publication
(10) Pub. No.: US 2025/0021756 A1
(43) Pub. Date: Jan. 16, 2025

(54) Chinese Spelling Correction Method, System, Storage Medium and Terminal

(71) Applicant: Shanghai Midu Science and Technology Co., LTD., Shanghai (CN)

(72) Inventors: Gen LI, Shanghai (CN); Yidong LIU, Shanghai (CN); Jun WANG, Shanghai (CN)

(73) Assignee: Shanghai Midu Science and Technology Co., LTD., Shanghai (CN)

(21) Appl. No.: 18/572,200

(22) PCT Filed: Apr. 27, 2022
(86) PCT No.: PCT/CN2022/089445

§ 371 Date: Dec. 20, 2023

(30) Foreign Application Priority Data
Mar. 31, 2022 (CN) 2022103428754

(51) Int. Cl. G06F 40/232; G06F 40/53

(52) U.S. Cl. CPC G06F 40/232; G06F 40/53

(57) ABSTRACT

The disclosure provides a Chinese spelling correction method, including: obtaining a text sequence, a pinyin sequence and a picture sequence of a Chinese input text file; based on the text sequence, the pinyin sequence and the picture sequence respectively extracting word meaning features, phonetic features and glyph features of the Chinese input text file; integrating the word meaning features, phonetic features and glyph features; based on the integrated word meaning features, phonetic features and glyph features, performing a correctness prediction, a pinyin prediction and a character prediction on the Chinese input text file to obtain the corrected Chinese output text file; performing rationality judgment on the Chinese output text file to obtain the final Chinese text file. The method is based on multi-modal neural networks and language models to realize the recognition and correction of word meanings, phonetics and glyphs in Chinese spelling, thus effectively improving accuracy and practicality.

### TECHNICAL FIELD

The present disclosure relates to the technical field of information processing, and in particular to a Chinese spelling correction method, system, storage medium and terminal.

### BACKGROUND

Chinese spelling check is a basic task in Chinese Natural Language Processing (NLP), which aims to automatically detect and correct spelling errors in Chinese sentences. These error types include homophone errors, homograph errors, and confusable word errors that are often made in Chinese language writing. For example, “talk and laugh carry a breeze ( [symbol] )” is often mistakenly written as “sound of talk and laugh is like a wind breeze ( [symbol] )”.

The existing spelling correction methods based on lexicon and rules have poor generalization and require a lot of human resources to maintain a rule library; and as time goes by, there are more and more rules, some may conflict with each other between rules. So many kinds of problems arise. For example, some traditional error correction method often changes “I speak German well” to “I speak language well.” This is because ‘I’ often forms a phrase together with ‘the’ in Chinese.

At present, Chinese spelling correction methods based on deep learning can improve a certain degree of generalization ability, but they still cannot meet the accuracy requirement in actual needs, and some false positives will inevitably occur. For example, change “I received a piece of news” to “I received a message.” Although the revised text is also correct, here the original text does not need to be modified.

### SUMMARY

The present disclosure provides a Chinese spelling correction method and system, storage medium and terminal. The disclosure recognizes and corrects errors in the real meaning, phonetic and glyph of the Chinese spelling, based on a multi-modal neural network and a language model. The technique effectively improves the accuracy and practicality.

The present disclosure provides a Chinese spelling error correction method, which includes the following steps: obtaining the text sequence, the pinyin sequence and picture sequence corresponding to the Chinese input text file; extracting the word meaning features, phonetic features and glyph features based on the text sequence, the pinyin sequence and the picture sequence of the Chinese input text file respectively; integrating the word meaning features, the phonetic features and the glyph features; performing correctness prediction, pinyin prediction and character prediction on the Chinese input text file to obtain the corrected Chinese output text file, based on the word meaning features, phonetic features and glyph features; and performing rationality judgment on the Chinese output text file to obtain the final Chinese text file.

In an embodiment of the present disclosure, respectively extracting the word meaning features, phonetic features and glyph features of the Chinese input text file based on the text sequence, the pinyin sequence and the picture sequence includes the following steps:
extracting word meaning features of the Chinese input text file based on a word meaning encoder;
extracting phonetic features of the Chinese input text file based on a phonetic encoder; and
extracting glyph features of the Chinese input text file based on a glyph encoder.

In one embodiment of the present disclosure, the word meaning encoder adopts the Transformer Blocks model; the phonetic encoder adopts a GRU neural network; and the glyph encoder adopts a ResNet neural network.

In an embodiment of the present disclosure, integrating the word meaning features, the phonetic features and the glyph features includes the following steps:
when a word meaning error occurs, increasing the weight of the word meaning feature;
when a phonetic error occurs, increasing the weight of the phonetic feature; and
when a glyph error occurs, increasing the weight of the glyph feature.

In one embodiment of the present disclosure, performing correctness prediction, pinyin prediction, and character prediction on the Chinese input text file based on the integrated word meaning features, phonetic features, and glyph features to obtain the corrected Chinese output text file includes the following steps:
performing spelling error detection on the Chinese input text file based on a correctness predictor; and
when a spelling error is detected, performing pinyin recognition on the Chinese input text file based on a pinyin predictor.

According to the integrated word meaning features, phonetic features, glyph features, the spelling errors and the recognized pinyin, the Chinese output text file is output based on the character predictor.

In one embodiment of the present disclosure, a rationality judgment is made on the Chinese output text file based on a language model.

In one embodiment of the present disclosure, the language model adopts a GPT (Generative Pre-Training) language model or an N-Gram language model.

The disclosure provides a Chinese spelling correction system, which includes an acquisition module, an extraction module, an integration module, an error correction module and a judgment module.

The acquisition module obtains the text sequence, pinyin sequence and picture sequence corresponding to the Chinese input text file.

The extraction module respectively extracts word meaning features, phonetic features and glyph features of the Chinese input text file based on the text sequence, the pinyin sequence and the picture sequence.

The integration module integrates the word meaning features, the phonetic features and the glyph features.

The error correction module performs correctness prediction, pinyin prediction, and character prediction on the Chinese input text file based on the integrated word meaning features, phonetic features, and glyph features to obtain an error-corrected Chinese output text file.

The judgment module judges the rationality of the Chinese output text file to obtain the final Chinese text file.

The disclosure also provides a storage medium on which a computer program is stored. When the computer program is executed by a processor, the above-mentioned Chinese spelling correction method is implemented.

The disclosure provides a Chinese spelling correction terminal, which includes: a processor and a memory.

The memory stores computer programs.

The processor executes the computer program stored in the memory, so that the Chinese spelling correction terminal executes the above-mentioned Chinese spelling correction method.

As mentioned above, the Chinese spelling correction method and system, storage medium and terminal of the present disclosure have the following beneficial effects.

(1) It can realize the recognition and correction of word meanings, phonetics and glyphs in Chinese spelling based on multi-modal neural networks, and avoid false positives in Chinese spelling error detection based on language models.

(2) It can effectively prevent false alarms and improve user experience.

(3) It further improves the generalization ability of Chinese spelling correction method, effectively improves the accuracy, and meets the needs of practical application scenarios.

### BRIEF DESCRIPTION OF THE DRAWINGS

FIG. 1 shows a flow chart of a Chinese spelling correction method in one embodiment of the present disclosure.

FIG. 2 shows a framework diagram of the Chinese spelling correction method in one embodiment of the present disclosure.

FIG. 3 shows a schematic structural diagram of a Chinese spelling correction system in one embodiment of the present disclosure.

FIG. 4 shows a schematic structural diagram of a Chinese spelling correction terminal in one embodiment of the present disclosure.

### REFERENCE NUMERALS

31 Acquisition module
32 Extraction module
33 Integration module
34 Error correction module
35 Judgment module
41 Processor
42 Memory

### DETAILED DESCRIPTION OF THE PREFERRED EMBODIMENTS

The following describes the embodiments of the present disclosure through specific examples. Those skilled in the art can easily understand other advantages and effects of the present disclosure from the content disclosed in this specification. The present disclosure can also be implemented or applied through other different specific embodiments. Various details in this specification can also be modified or changed in various ways based on different viewpoints and applications without departing from the spirit of the present disclosure.

It should be noted that the diagrams provided in this embodiment only illustrate the basic concept of the present disclosure in a schematic manner. The drawings only show the components related to the present disclosure and do not follow the actual implementation of the component numbers, shapes and sizes. In actual implementation, the type, quantity and proportion of each component can be arbitrarily changed, and the component layout may also be more complex.

The Chinese spelling correction method and system, storage medium and terminal of the present disclosure are based on multi-modal neural networks to realize the recognition and correction of word meanings, phonetics and glyphs in Chinese spelling, and are based on language models to avoid false positives in Chinese spelling, thereby effectively improving the accuracy of Chinese spelling correction and the user experience.

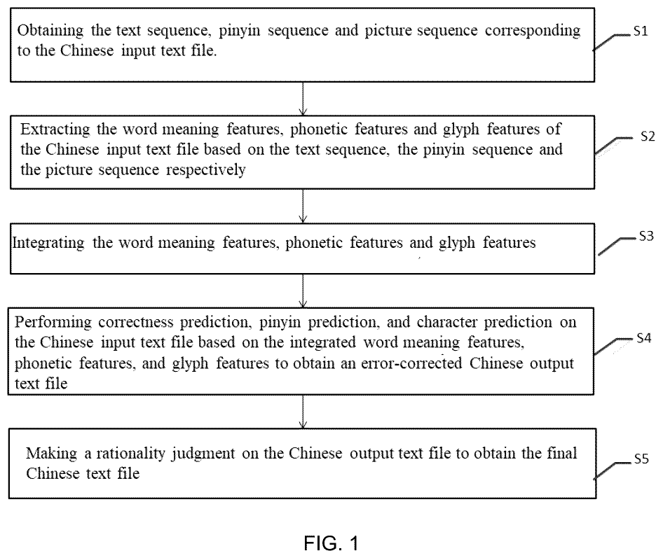

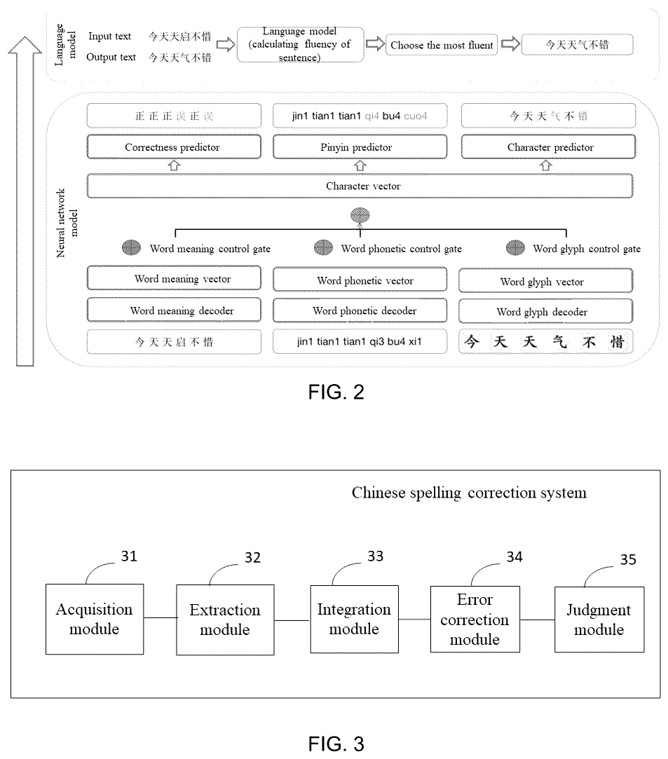

As shown in FIGS. 1 and 2, in one embodiment, the Chinese spelling correction method of the present disclosure includes the following steps:

Step S1: Obtaining the text sequence, pinyin sequence and picture sequence corresponding to the Chinese input text file.

Specifically, when the user inputs the Chinese text, the text sequence, pinyin sequence and picture sequence of the Chinese text are first extracted. As shown in FIG. 2, in one embodiment, the text sequence is “( [symbol] )”, the pinyin sequence is “jin1 tian1 tian1 qi3 bu4 xi1”, and the picture sequence is the Chinese text image contained on the terminal device.

Step S2: Extracting the word meaning features, phonetic features and glyph features of the Chinese input text file based on the text sequence, the pinyin sequence and the picture sequence respectively.

Specifically, for the text sequence, the pinyin sequence and the picture sequence, three feature encoders are respectively used to extract the word meaning features, phonetic features and glyph features of the above-mentioned Chinese input text file.

In an embodiment of the present disclosure, respectively extracting the word meaning features, phonetic features and glyph features of the Chinese input text file based on the text sequence, the pinyin sequence and the picture sequence includes the following steps.

21) Extracting the word meaning features of the Chinese input text file based on the word meaning encoder.

Preferably, the word meaning encoder adopts the Transformer Blocks model.

22) Extracting the phonetic features of the Chinese input text file based on the phonetic encoder.

Preferably, the phonetic encoder applies Gated Recurrent Unit (GRU) neural network, which is a variant of Long Short-Term Memory (LSTM) neural network, which maintains the function of LSTM while making the structure simpler.

23) Extracting the glyph features of the Chinese input text file based on the glyph encoder.

Preferably, the glyph encoder applies a Residual Network (ResNet) neural network, which is easy to optimize and can improve accuracy by adding considerable depth. The internal residual block uses skip connections. It alleviates the gradient vanishing problem caused by increasing depth in deep neural networks.

Step S3: Integrating the word meaning features, phonetic features and glyph features.

Specifically, the word meaning feature, the phonetic feature and the glyph feature are integrated through the word meaning control gate, the phonetic control gate and the glyph control gate, thereby determining the weights of the word meaning feature, the phonetic feature and the glyph feature in the Chinese spelling error correction process, so as to facilitate accurate identification and correction.

In an embodiment of the present disclosure, integrating the word meaning features, the phonetic features and the glyph features includes the following steps:

31) when word meaning errors occur, increasing the weight of the word meaning feature.

32) when phonetic errors occur, increasing the weight of the phonetic feature; and 33) when glyph errors occur, increasing the weight of the glyph feature.

Specifically, when the Chinese input text file contains errors in certain aspects of word meaning, phonetic, and glyph, the corresponding feature weight will increase, thereby increasing the accuracy of subsequent error correction. The specific proportion of weight increase can be set flexibly in any practical application scenarios.

Step S4: Performing correctness prediction, pinyin prediction, and character prediction on the Chinese input text file based on the integrated word meaning features, phonetic features, and glyph features to obtain an error-corrected Chinese output text file.

Specifically, in order to further improve the robustness and interpretability of Chinese spelling correction, after feature integration, predictions of the Chinese input text file in three aspects: correctness prediction, pinyin prediction, and character prediction need to be performed.

In one embodiment of the present disclosure, performing correctness prediction, pinyin prediction, and character prediction on the Chinese input text file based on the integrated word meaning features, phonetic features, and glyph features to obtain the corrected Chinese output text file includes the following steps.

41) Performing spelling error detection on the Chinese input text file based on the correctness predictor.

Specifically, the correctness predictor has detection capabilities and can detect spelling errors in the Chinese input text file.

42) When a spelling error is detected, performing a pinyin recognition on the Chinese input text file based on the pinyin predictor.

Specifically, the pinyin predictor is capable of outputting correct pinyin information based on its knowledge when a spelling error is detected, so as to better incorporate Chinese pinyin knowledge and facilitate subsequent correction of errors.

43) Outputting the Chinese output text file based on the character predictor, after combining the integrated word meaning features, phonetic features and glyph features, the identified spelling errors and the recognized pinyin knowledge.

Specifically, the character predictor has a correction ability. With the assistance of the detection ability of the correctness predictor and the knowledge of the pinyin predictor, and after integrating the word meaning features, phonetic features and glyph features, the correction of Chinese input text file is achieved and the corrected Chinese output text file is obtained. As shown in FIG. 2, the correctness predictor detects spelling errors in the fourth and sixth characters of the Chinese input text file “ [symbol] ”; the pinyin predictor outputs accurate pinyin information “jin1 tian1 tian1 qi4 bu4 cuo4”. The character predictor outputs the correct Chinese output text file “the weather is good today ( [symbol] )” based on the detected spelling errors, correct pinyin information and the integrated word meaning features, phonetic features and glyph features.

Step S5: Making a rationality judgment on the Chinese output text file to obtain the final Chinese text file.

Specifically, the rationality judgment is made on the Chinese output text file based on the language model. This is because after error correction is performed on the Chinese input text file, the rationality of the error correction behavior needs to be judged to prevent the occurrence of false positives. The language model can calculate the fluency of the Chinese output text file and select the most fluent expression as the final Chinese text file. As shown in FIG. 2, the language model performs fluency calculation on the Chinese output text file “The weather is good today”, determines that it is a reasonable expression, and then outputs the final Chinese text file “The weather is good today”.

Preferably, the language model adopts Generative Pre-Training language model (GPT) or N-Gram language model. The GPT language model adopts the training mode of Pre-training+Fine-tuning, which can be used for tasks such as classification, reasoning, question and answer, and similarity analysis. The N-Gram language model can predict or evaluate whether a sentence is reasonable, and evaluate the degree of difference between two strings.

As shown in FIG. 3, in one embodiment, the Chinese spelling correction system of the present disclosure includes an acquisition module 31, an extraction module 32, an integration module 33, an error correction module 34 and a judgment module 35.

The acquisition module 31 acquires the text sequence, pinyin sequence and picture sequence corresponding to the Chinese input text file.

The extraction module 32 is connected to the acquisition module 31 and respectively extracts word meaning features, phonetic features and glyph features of the Chinese input text file based on the text sequence, the pinyin sequence and the picture sequence.

The integration module 33 is connected to the extraction module 32 and integrates the word meaning features, the phonetic features and the glyph features.

The error correction module 34 is connected to the integration module 33 and performs correctness prediction, pinyin prediction and character prediction on the Chinese input text file based on the integrated word meaning features, phonetic features and glyph features to obtain the error-corrected Chinese output text file.

The judgment module 35 is connected to the error correction module 34 and judges the rationality of the Chinese output text file to obtain the final Chinese text file.

Among them, the structures and principles of the acquisition module 31, the extraction module 32, the integration module 33, the error correction module 34 and the judgment module 35 are described in the steps in the above-mentioned Chinese spelling correction method, so they will not be described again here.

It should be noted and understood that the division of each module of the above device is only a division of logical functions. In actual implementation, they can be fully or partially integrated into a physical entity, or they can also be physically separated. And these modules can all be implemented in the form of software calling through processing components; they can also all be implemented in the form of hardware; some modules can also be implemented in the form of software calling through processing components, and some modules can be implemented in the form of hardware. For example, an x module may be a separate processing element or may be integrated in one of the chips of the above device, and furthermore, it may be in the form of program codes stored in the memory of the above device, which is executed by one of the processing elements of the above device to perform the functions of the above x module. The implementation of other modules is similar. In addition, all or part of these modules can be integrated together or implemented independently. The processing element described here may be an integrated circuit with signal processing capabilities. During the implementation process, each step of the above method or each of the above modules can be completed by the integrated logic circuits of hardware in the processor element or instructions that in the form of software.

For example, the above modules may be one or more integrated circuits to implement the above methods, such as: one or more Application Specific Integrated Circuits (ASICs for short), or one or more microprocessors Digital Signal Processor (DSP for short), or one or more Field Programmable Gate Array (FPGA for short)), etc. For another example, when one of the above modules is implemented in the form of program codes that are called by a processing element, the processing element can be a general-purpose processor, such as a Central Processing Unit (CPU for short) or other processors that can call program code. For another example, these modules can be integrated together and implemented in the form of a system-on-a-chip (SOC for short).

The storage medium of the present disclosure stores a computer program, which is characterized in that when the program is executed by a processor, the above-mentioned Chinese spelling correction method is implemented. The storage medium includes: ROM, RAM, magnetic disks, USB disks, memory cards or optical disks and other media that can store program codes.

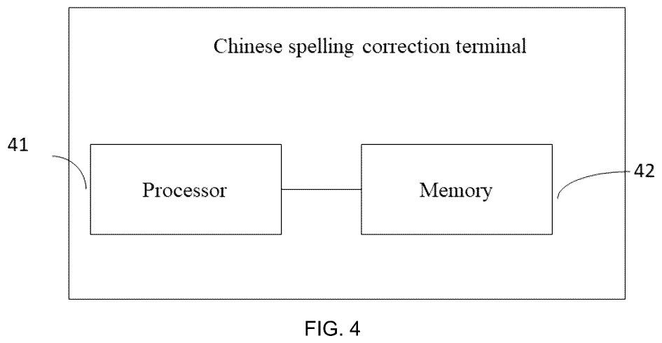

As shown in FIG. 4, in one embodiment, the Chinese spelling correction terminal of the present disclosure includes: a processor 41 and a memory 42.

The memory 42 stores computer programs.

The memory 42 includes various media that can store program codes, such as ROM, RAM, magnetic disk, USB disk, memory card or optical disk.

The processor 41 is connected to the memory 42 and is used to execute the computer program stored in the memory 42 so that the Chinese spelling correction terminal executes the above-mentioned Chinese spelling correction method.

Preferably, the processor 41 can be a general-purpose processor, including a Central Processing Unit (CPU for short), a Network Processor (NP for short), etc.; it can also be a Digital Signal Processor (DSP for short), an Application Specific Integrated Circuit (ASIC for short), a Field Programmable Gate Array (FPGA for short) or other programmable logic devices, discrete gates or transistor logic devices, and discrete hardware components.

In summary, the Chinese spelling correction method and system, storage medium and terminal of the present disclosure can realize the recognition and correction of word meaning, phonetics and glyphs in Chinese spelling based on multi-modal neural networks and language models, which effectively prevents false alarms and improves the user experience. In addition, they further improve the generalization ability of Chinese spelling correction, effectively improve accuracy, and meet the needs of actual application scenarios. Therefore, the present disclosure effectively overcomes various shortcomings in the existing techniques and has high industrial utilization value.

The above embodiments only illustrate the principles and effects of the present disclosure, but are not intended to limit the present disclosure. Anyone familiar with this technology can modify or change the above embodiments without departing from the spirit and scope of the disclosure. Therefore, all equivalent modifications or changes made by those with ordinary knowledge in the technical field without departing from the spirit and technical ideas disclosed in the present disclosure shall still be covered by the claims of the present disclosure.

1. A method for correcting Chinese spelling errors, comprising following steps:
obtaining a text sequence, a pinyin sequence, and a picture sequence from a Chinese input text file;
extracting word meaning features, phonetic features, and glyph features of the Chinese input text file based on the text sequence, the pinyin sequence and the picture sequence respectively;
integrating the word meaning features, the phonetic features and the glyph features;
performing a correctness prediction, a pinyin prediction, and a character prediction on the Chinese input text file based on the integrated word meaning features, phonetic features, and glyph features to obtain a Chinese output text file which has been error-corrected; and
performing a rationality judgment on the Chinese output text file to obtain a final Chinese text file.

2. The method according to claim 1, wherein the extracting the word meaning features, the phonetic features and the glyph features of the Chinese input text file based on the text sequence, the pinyin sequence and the picture sequence respectively further comprises following steps:
extracting the word meaning features of the Chinese input text file based on a word meaning encoder;
extracting the phonetic features of the Chinese input text file based on a phonetic encoder; and
extracting the glyph features of the Chinese input text file based on a glyph encoder.

3. The method according to claim 2, wherein the word meaning encoder adopts a Transformer Blocks model; wherein the phonetic encoder adopts a GRU neural network; and wherein the glyph encoder adopts a ResNet neural network.

4. The method according to claim 1, wherein the integrating the word meaning features, the phonetic features and the glyph features comprises following steps:
increasing a weight of the word meaning features when a word meaning error occurs;
increasing a weight of the phonetic features when a phonetic error occurs; and
increasing a weight of the glyph features when a glyph error occurs.

5. The method according to claim 1, wherein the performing the correctness prediction, the pinyin prediction, and the character prediction on the Chinese input text file based on the integrated word meaning features, phonetic features, and glyph features to obtain the Chinese output text file further comprises following steps:
performing a spelling error detection on the Chinese input text file based on a correctness predictor;
performing a pinyin identification based on a pinyin predictor on the Chinese input text file when the spelling error is detected; and
outputting the Chinese output text file based on a character predictor according to the integrated word meaning features, the phonetic features, the glyph features, the spelling error and the identified pinyin.

6. The method according to claim 1, further comprising:
performing a rationality judgment on the Chinese output text file based on a language model.

7. The method according to claim 6, wherein the language model comprises a Generative Pre-Training (GPT) language model or an N-Gram language model.

8. A Chinese spelling correction system, comprising: an acquisition module, an extraction module, an integration module, an error correction module, and a judgment module;
wherein the acquisition module obtains a text sequence, a pinyin sequence and a picture sequence corresponding to a Chinese input text file;
wherein the extraction module respectively extracts word meaning features, phonetic features and glyph features of the Chinese input text file based on the text sequence, the pinyin sequence and the picture sequence;
wherein the integration module integrates the word meaning features, the phonetic features and the glyph features;
wherein the error correction module performs a correctness prediction, a pinyin prediction, and a character prediction on the Chinese input text file based on the integrated word meaning features, phonetic features, and glyph features to obtain a Chinese output text file which is error-corrected; and
wherein the judgment module judges rationality of the Chinese output text file to obtain a final Chinese text file.

9. A storage medium with a computer program stored thereon, wherein when the computer program is executed by a processor, the method for correcting Chinese spelling errors according to claim 1 is implemented.

10. A Chinese spelling correction terminal, comprising: a processor and a memory;
wherein the memory stores computer programs; and
wherein the processor executes the computer programs stored in the memory, so that the Chinese spelling correction terminal executes the method for correcting Chinese spelling errors according to claim 1.
